(19) United States
(12) Patent Application Publication
(10) Pub. No.: US 2006/0287152 A1
(43) Pub. Date: Dec. 21, 2006

(54) Supplying lubricant to a pinion carrier of an automatic transmission

(76) Inventors: Brian Bishop, Ira Township, MI (US); Michael Brockway, Pinckney, MI (US); Mohamed Redissi, Ann Arbor, MI (US); Norm Bird, Plymouth, MI (US); Jim Gooden, Canton, MI (US); Robert Meyer, Canton, MI (US)

Correspondence Address: MACMILLAN, SOBANSKI & TODD, LLC, ONE MARITIME PLAZA - FIFTH FLOOR, 720 WATER STREET, TOLEDO, OH, 43604, US

(21) Appl. No.: 11/157,235

(22) Filed: Jun. 21, 2005

(51) Int. Cl. F16H 57/04; F16H 57/08

(52) U.S. Cl. 475/159; 475/331

(57) ABSTRACT

An assembly for a hydraulically actuated automatic transmission comprising a balance dam, a carrier partially enclosing the balance dam, and a pinion shaft secured to the carrier having a fluid passage interconnecting the balance dam and an outer surface of the pinion shaft. Fluid exiting the passage is used to lubricate a bearing supported on the pinion shaft.

### BACKGROUND OF THE INVENTION

The present invention relates generally to the field of planetary gear sets for automatic transmissions. More particularly it pertains to supplying pressurized hydraulic lubricant to bearings that support pinions on a pinion carrier assembly.

In automatic transmissions disclosed in the prior art, a planet carrier assembly of a front gear set is mated to a balance dam piston assembly of a forward clutch by an external spline formed on the carrier. Fluid overflow from the balance dam enters the forward clutch assembly without entering or flowing through the gear set. A needle bearing, located on the pinion shaft, is lubricated from a plastic lube deflector, which catches fluid flung radially by centrifugal force from a nearby axial thrust bearing assembly.

It is preferred that both the balance dam and a pinion shaft lube feed source be integrated into one part, such that hydraulic fluid flows through the pinion shaft needle bearing before entering the clutch pack. This action reduces the number of components and allows a simplified assembly process. In addition, overall transmission lash can be reduced by eliminating the spline between the balance dam and carrier, thereby eliminating a potential leak path between the pinion shaft and lube deflector.

### SUMMARY OF THE INVENTION

The integrated carrier-balance dam assembly of the present invention is applicable to any transmission design having a planet carrier adjacent to a hydraulically actuated clutch assembly. It requires no piston in the balance dam. By combining the balance dam and carrier, it simplifies the assembly procedure and eliminates lash produced by a spline connection between previously mated components.

The external diameter of the carrier contains a seal that defines the outer balance point for the dam. The planet pinion carrier contains cross drilled pinion shafts, which are open to the fluid between a forward clutch piston and the carrier. The balance exit point for the oil dam fluid is defined by the radial location of the drilled pinion shaft holes. By orientating the radial drilled pinion shaft hole, the balance exit point is variable, thereby allowing flexibility in clutch balance.

To eliminate any restriction through the pinion needle bearings during clutch stroke, additional fluid exit holes are added at a lower radial dimension. 1o The assembly provides a direct lube feed source for the pinion shaft and ensures that the shafts are always completely full of oil.

It requires no separate oil dam assembly to retrieve oil radial spun from a nearby axial thrust bearing. Because the feed path of the pinion shafts is within the sealed balance cavity, the potential leak path between the pinion shaft and lube deflector of the previous design is eliminated.

Because the integrated planet carrier and balance dam assembly of this invention simplifies the assembly operation, it reduces the overall cost of the assembly. Substantially all of the hydraulic fluid exiting the balance dam flows through the needle bearings on the carrier before exiting the carrier. The rate of pressurized fluid flow to the pinion needle bearings increases as a function of rotational speed of the pinions, due a centrifugal pressure head.

An assembly for a hydraulically-actuated automatic transmission includes a balance dam, a planet carrier, and pinion shafts, each secured to the carrier and formed with a fluid passage that interconnects the balance dam and an outer surface of the pinion shaft. Fluid exiting the balance dam passes through ports in the carrier, into the passages, to the outer surface of the pinion shafts where it lubricates a bearing supported on each pinion shaft.

### DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 is a cross-section taken through a plane of a portion of automatic transmission for a motor vehicle showing the integrated carrier-balance dam according to this invention;

FIG. 2 is a cross-section similar to that of FIG. 1, but taken at a diametric plane, showing the carrier and its components in greater detail;

FIG. 3 is a perspective view of the servo hub;

FIG. 4 is a perspective view of a carrier plate;

FIG. 5 is a perspective view of a Belleville spring; and

FIG. 6 is cross-section through a diametric plane of a pinion shaft.

### DESCRIPTION OF THE PREFERRED EMBODIMENT

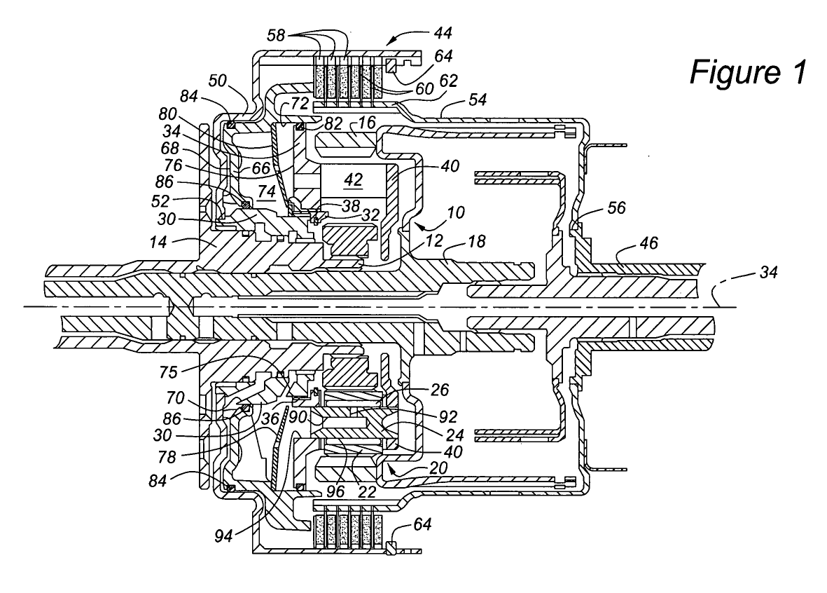

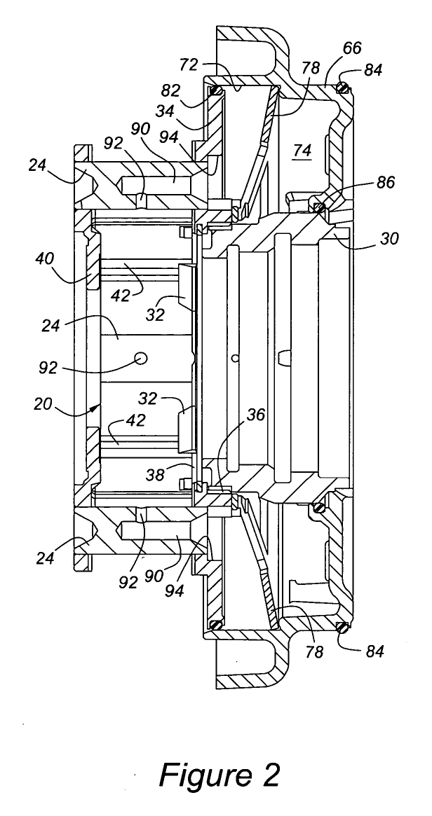

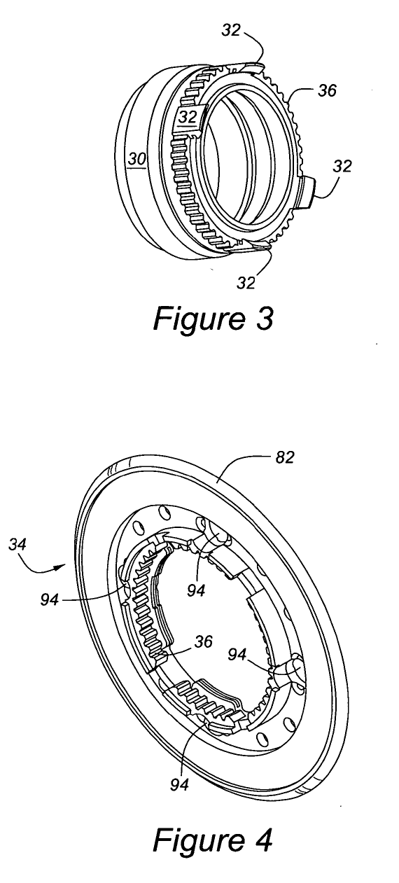

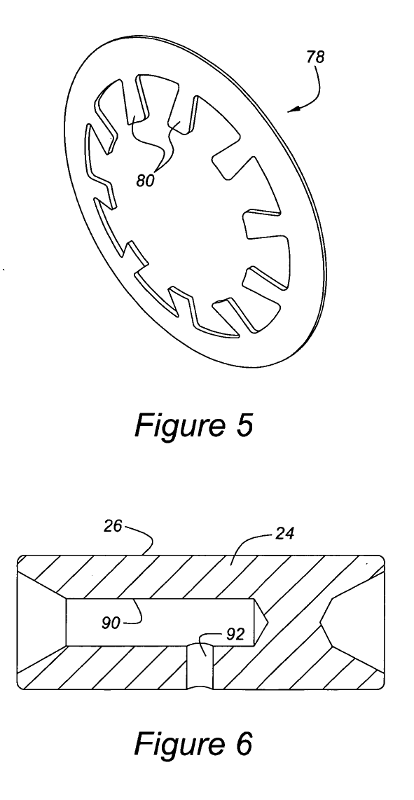

Referring first to FIG. 1, a planetary gear set 10 for an automatic transmission, of the type used in a motor vehicle, includes a sun gear 12 formed on the stator 14 of a hydraulic pump, a ring gear 16 secured to an input shaft 18, a carrier 20, and a set of planet pinions 22, each pinion supported on the carrier for rotation about the axis of a pinion shaft 24. The opposite axial ends of each pinion shaft 24 are secured to the carrier 20. A needle bearing 26, located on the outer surface of each pinion shaft 24, supports a planet pinion 22.

A hub 30, supported on the stator 14 for rotation, includes four legs 32, angularly space about a longitudinal axis 34 of the assembly. The hub 30 is driveably connected to a plate 34 of the carrier 20 at a spline 36, and the axial position of the hub is secured to plate 34 by a snap ring 38. Carrier 20 includes a second plate 40, which is spaced axially from plate 34 by four legs 42 that extend axially and are angularly spaced about axis 34.

A hydraulically actuated clutch 44, such as the forward clutch of an automatic transmission, alternately produces a drive connection between the carrier 20 and an intermediate shaft 46 when clutch 44 is engaged and releases the drive connection when the clutch is disengaged. A clutch cylinder 50 is secured at a welded connection 52 to the hub 30, which is secured to the carrier 20. Intermediate shaft 46 is secured to a hub 54 of clutch 44 at a welded connection 56. Clutch 44 includes multiple spacer plates 58, splined to the inner surface of the clutch cylinder 50, and multiple friction discs 60, splined to the outer surface 62 of the clutch hub 54. A blocker ring 64, secured to the cylinder 50, limits the range of motion of the friction discs 60 and spacer plates 58 in the axial direction when clutch 44 is engaged.

Clutch 44 is actuated by a hydraulic servo that includes a piston 66, which is located for axial displacement within cylinder 50. Servo hub 30 is formed with a fluid passage 70, through which hydraulic fluid is supplied to a volume 68 of cylinder 50 in order to displace piston 66 rightward into engagement. Servo hub 30 is also formed with a fluid passage 75 through which hydraulic fluid is supplied to a balance dam 74 located on the opposite side of the clutch piston 66 from the cylinder volume 68.

Piston 66 is formed with a surface 72, which partially encloses the balance dam 74, and the carrier plate 34 is formed with a surface 76, which partially encloses the balance dam. A Belleville spring 78, located within the balance dam 74, includes an outer ring that bears against the piston 66 and radial fingers 80 that are secured against displacement at their radially inner end. The Belleville spring 78 resists axial displacement of piston 66 rightward from the position shown in FIG. 1, and it restores the piston to the position shown in FIG. 1 when hydraulic pressure in cylinder volume 68 is vented.

An O-ring 82, fitted within a recess at the radial outer surface of carrier plate 34, provides an elastic, dynamic seal at piston surface 72 against the passage of hydraulic fluid as the pistons moves relative to the carrier 20. Another O-ring 84, fitted in a recess on the outer surface of piston 66, seals cylinder volume 68 against the passage of hydraulic fluid between the piston and cylinder 50. Similarly, O-ring 86, fitted in a recess formed in the radial inner surface of piston 66, seals against the passage of hydraulic fluid between piston 66 and the servo hub 30.

Each pinion shaft 24 of the carrier 20 is formed with an axial passage portion 90 and a radial passage portion 92, which extends radially outward from the axial passage portion. Each pinion shaft 24 is secured to the carrier plates 34, 40, preferably by deforming the ends of each pinion shaft radially outward into engagement with the carrier plates. Carrier plate 34 is formed with multiple exit ports 94, each port aligned with a pinion shaft 24 such that the balance dam 74 is continually open to the passages 90, 92 of the pinion shaft 24. Each radial passage 92 has an exit port at the outer surface 96 of the pinion shaft 24, which port allows hydraulic fluid from the balance dam to flow continually through the pinion shaft 24 to the needle bearings 26. The angular position of the radial passages 92 can be adjusted about the axis of the respective pinion shaft 24 in order to adjust the balance forces on the piston 66.

In operation, when clutch cylinder volume 68 is pressurized, piston 66 moves rightward in cylinder 50 against the spring 78, thereby forcing the pack of spacer plates 58 and friction discs 60 into mutual frictional contact. This action engages the clutch 44 and produces a drive connection between carrier 20 and intermediate shaft 46. With clutch 44 engaged and sun gear 12 held against rotation on stator 14, the gear set 10, whose input is shaft 18 and whose out put is carrier 20, underdrives shaft 46 in a forward direction relative to the speed and direction of input shaft 18. Hydraulic transmission fluid, which is continually supplied to balance dam 74, flows continually to the bearings 26 on the pinion shafts 24.

When clutch volume 68 is vented, piston 66 moves leftward in cylinder 50 aided by the force of return spring 78, thereby releasing the frictional contact among the spacer plates 58 and friction discs 60. This action disengages the clutch 44 and releases the drive connection between carrier 20 and intermediate shaft 46. Hydraulic transmission fluid flows continually to the bearings 26 on the pinion shafts 24 when clutch 44 is disengaged.

In accordance with the provisions of the patent statutes, the present invention has been described in what is considered to represent its preferred embodiment. However, it should be noted that the invention can be practiced otherwise than as specifically illustrated and described without departing from its spirit or scope.

What is claimed is:

1. An assembly for a hydraulically actuated automatic transmission comprising:
a balance dam;
a carrier partially enclosing the balance dam; and
a pinion shaft secured to the carrier, including a fluid passage interconnecting the balance dam and an outer surface of the pinion shaft.

2. The assembly of claim 1 further comprising:
a pinion; and
a bearing located between the pinion and the outer surface of the pinion shaft, for supporting the pinion on the pinion shaft.

3. The assembly of claim 1 further comprising:
a friction element for alternately holding and releasing a drive connection between components of the transmission; and
a servo for actuating the friction element, including a piston partially enclosing the balance dam.

4. The assembly of claim 1 further comprising:
a friction element for alternately holding and releasing a drive connection between components of the transmission;
a servo for actuating the friction element, including a piston partially enclosing the balance dam; and
a servo hub including a surface partially enclosing the balance dam, and a second fluid passage communicating with the balance darn.

5. The assembly of claim 1 further comprising:
a friction element for alternately holding and releasing a drive connection between components of the transmission;
a servo for actuating the friction element including a piston that partially encloses the balance dam and moves relative to the carrier; and
a first seal for resisting fluid flow between the carrier and the piston; and

6. The assembly of claim 1 further comprising:
a friction element for alternately holding and releasing a drive connection between components of the transmission;
a servo for actuating the friction element including a piston that partially encloses the balance dam and moves relative to the carrier;
a surface on which the piston is supported for movement;
a first seal for resisting fluid flow between the carrier and the piston; and
a second seal for resisting fluid flow between said surface and the piston.

7. The assembly of claim 1 wherein the surface, on which the piston is supported for movement, includes a second fluid passage communicating with the balance dam.

8. The assembly of claim 1 further comprising:
a friction element for alternately holding a drive connection between components of the transmission when the friction element is engaged and for releasing the drive connection when the friction element is disengaged; and
a servo including a cylinder, a third passage for carrying hydraulic fluid to the cylinder, a piston located in the cylinder and actuated by the pressure in the cylinder to engage the friction element, and a spring for urging the piston to disengage the friction element.

9. The assembly of claim 1 wherein the fluid passage of the pinion shaft includes an axial portion extending from the balance dam along the pinion shaft, and a radial portion extending from the axial portion to the outer surface of the pinion shaft.

10. An assembly for hydraulically actuated automatic transmission comprising:
a balance dam;
a piston including a surface partially enclosing the balance dam; and
a carrier comprising a first plate partially enclosing the balance dam and having multiple openings communicating with the balance dam [spaced angularly about an axis], a second plate spaced axially from the first plate, and pinion shafts extending axially between and secured to the first plate and the second plate, each pinion shaft including a passage aligned with an opening and hydraulically connecting the balance dam and an outer surface of the respective pinion shaft.

11. The assembly of claim 10 further comprising:
multiple pinions, each pinion supported on a pinion shaft; and
multiple bearings, each bearing located between a pinion and the outer surface of a pinion shaft and supporting the pinion on the pinion shaft.

12. The assembly of claim 10 further comprising:
a friction element for alternately holding and releasing a drive connection between components of the transmission; and
a servo for actuating the friction element, including a piston partially enclosing the balance dam.

13. The assembly of claim 10 further comprising:
a friction element for alternately holding and releasing a drive connection between components of the transmission;
a servo for actuating the friction element, including a piston partially enclosing the balance dam; and
a servo hub including a surface partially enclosing the balance dam, and a second fluid passage communicating with the balance dam.

14. The assembly of claim 10 further comprising:
a friction element for alternately holding and releasing a drive connection between components of the transmission;
a servo for actuating the friction element including a piston that partially encloses the balance dam and moves relative to the carrier; and
a first seal for resisting fluid flow between the carrier and the piston; and

15. The assembly of claim 10 further comprising:
a friction element for alternately holding and releasing a drive connection between components of the transmission;
a servo for actuating the friction element including a piston that partially encloses the balance dam and moves relative to the carrier;
a surface on which the piston is supported for movement;
a first seal for resisting fluid flow between the carrier and the piston; and
a second seal for resisting fluid flow between said surface and the piston.

16. The assembly of claim 15 wherein the surface, on which the piston is supported for movement, includes a second fluid passage communicating with the balance dam.

17. The assembly of claim 10 further comprising:
a friction element for alternately holding a drive connection between components of the transmission when the friction element is engaged and for releasing the drive connection when the friction element is disengaged; and
a servo including a cylinder, a third passage for carrying hydraulic fluid to the cylinder, a piston located in the cylinder and actuated by the pressure in the cylinder to engage the friction element, and a spring for urging the piston to disengage the friction element.

18. The assembly of claim 10 wherein the fluid passage of the pinion shaft includes an axial portion extending from the balance dam along the pinion shaft, and a radial portion extending from the axial portion to the outer surface of the pinion shaft.

19. A method for supplying lubricant to a bearing in an automatic transmission comprising the steps of:
(a) forming a balance dam having a fluid exit port;
(b) forming a pinion shaft having a passage that interconnects the outer surface of the shaft and an inlet port;
(c) hydraulically connecting the inlet port and exit port; and
(d) supplying hydraulic fluid to the balance dam.

20. The method of claim 19 further comprises the steps of:
locating a bearing on the outer surface of the pinion shaft; and
allowing fluid to flow from the exit port, through the passage to the bearing.
